(19) United States
(12) Patent Application Publication
(10) Pub. No.: US 2013/0070956 A1
(43) Pub. Date: Mar. 21, 2013

(54) SPEAKER

(71) Applicant: Takahito YAMANAKA, Daito-shi (JP)

(72) Inventor: Takahito YAMANAKA, Daito-shi (JP)

(73) Assignee: Funai Electric Co., Ltd., Osaka (JP)

(21) Appl. No.: 13/611,732

(22) Filed: Sep. 12, 2012

(30) Foreign Application Priority Data
Sep. 21, 2011 (JP) 2011-206098

(51) Int. Cl. H04R 1/00

(52) U.S. Cl. 381/433

(57) ABSTRACT

A speaker includes a speaker main body and attachment parts arranged to attach the speaker main body to an electronic apparatus such as a television. The speaker is attached to the electronic apparatus as a result of fitted holes in the attachment parts being fitted over projections on the electronic apparatus. Each of the attachment members includes a metal plate integral with a frame of the speaker main body and a rearward extension part that is bent from a side edge of the frame toward a back of the speaker main body and an inward extension part that is bent from the rearward extension part toward an inside of the speaker main body. Portions of the inward extension parts overlap with the speaker main body on the back side of the speaker main body. The fitted holes are provided in the inward extension parts.

### BACKGROUND OF THE INVENTION

1. Field of the Invention

The present invention relates to a speaker that is mounted on an electronic apparatus such as a television and that converts an electrical signal into sound and outputs the sound.

2. Description of the Related Art

Speakers having the configuration shown in FIGS. 5A, 5B, 6A, 6B, 7A, and 7B are known. The speaker 80 includes attachment parts 82 for attaching the speaker main body 81 to an apparatus body 90, and as a result of fitted holes 82o provided in the attachment parts 82 being respectively fitted over projecting parts 91 provided on the apparatus body 90 so that the speaker main body 81 is attached to the apparatus body 90. The apparatus body 90 is a case for an electronic apparatus such as a television.

The speaker 80 is attached to the apparatus body 90 in an attitude in which the front side of the speaker main body 81 is caused to face sound openings 92o provided in the front wall of the apparatus body 90. Heavy attachment paper 87 and attachment foam 88 are interposed between the front-side portion of the speaker main body 81 and the front wall 92 of the apparatus body 90. The attachment foam 88 is interposed between the heavy attachment paper 87 and the front wall 92 of the apparatus body 90 and pressed against the front wall 92 via the heavy attachment paper 87 by the speaker main body 81. Furthermore, attachment rubber 89 is interposed between the fitted hole 82o provided in each of the attachment parts 82 and the corresponding projecting part 91 provided on the apparatus body 90.

The attachment parts 82 are provided in positions in which the attachment parts 82 protrude from both side ends of the speaker main body 81 in the long-side direction (the direction parallel to the direction indicated by arrow X in the figures) toward the outside of the speaker main body 81 in the long-side direction. The attachment parts 82 are formed from a metal plate integrally with the frame 83 of the speaker main body 81, and each of the attachment parts 82 has a lateral extension part 84 and a rearward bent part 85. The lateral extension parts 84 extend from the frame 83 toward the outside of the speaker main body 81 in the long-side direction. The rearward bent parts 85 are bent from the lateral extension parts 85 toward the back of the speaker main body 81. That is, the rearward bent parts 85 are bent from the lateral extension parts at a bending angle of 90 degrees toward the back of the speaker main body 81 such that the bent lines created by bending intersect with the direction from the back side toward the front side of the speaker main body 81 (the direction indicated by arrow Z in the figures) (such that the bend lines are parallel to the long-side direction of the speaker main body 81). The fitted holes 82o are provided in the rearward bent parts 85.

Moreover, a speaker has been also known which includes attachment parts that are formed from a metal plate integrally with the frame of the speaker main body, and in which the attachment parts respectively have parts that are bent from both side ends of the speaker main body in the long-side direction toward the outside of the speaker main body in the long-side direction and extend toward the outside of the speaker main body in the long-side direction, with holes for attaching the speaker main body to the apparatus body being respectively provided in the outward extension parts (for example, see Japanese Patent Application Laid-Open Publication No. 2011-19170 and Japanese Patent Application Laid-Open Publication No. 2008-258753).

In the conventional speaker 80, the attachment parts are provided at positions in which the attachment parts 82 protrude outwardly in the long-side direction of the speaker main body 81 from both side ends of the speaker main body 81 in the long-side direction. Therefore, the size of the speaker 80 in the long-side direction is inevitably increased. As a result, the degree of freedom in the designing of electronic apparatuses on which the speaker 80 is mounted is low, which makes it difficult to improve the design characteristics of electronic apparatuses on which the speaker 80 is mounted.

In addition, the rearward bent parts 85 of the attachment parts 82 provided with the fitted holes 82o are bent such that the bent lines created by bending intersect with the direction from the back side toward the front side of the speaker main body 81. Because of this, in cases where the bending precision of the rearward bent parts 85 is poor, causing the angle of bending of the rearward bent parts 85 to be shifted from the proper angle (90 degrees), or in cases where unnecessary force is applied when the speaker 80 is attached to the apparatus body 90, causing the angle of bending of the rearward bent parts 85 to be altered from the proper angle, the speaker main body 81 ends up being attached to the apparatus body 90 in an improper attitude in which the direction from the back side toward the front side of the speaker main body 81 is not perpendicular to the front wall 92 of the apparatus body 90. If the speaker main body 81 ends up being attached to the apparatus body 90 in such an improper attitude, a gap is produced between the front wall 92 of the apparatus body 90 and the attachment foam 88, or the attachment foam 88 is pressed against the front wall 92 of the apparatus body 90 with a non-uniform force. As a result, the quality and pressure of the sound that is output from the speaker 80 will be deteriorated. Note that even if the disclosed content is applied to the inventions described in Japanese Patent Application Laid-Open Publication No. 2011-19170 and Japanese Patent Application Laid-Open Publication No. 2008-258753, the problems described above cannot be solved.

### SUMMARY OF THE INVENTION

In view of the above, preferred embodiments of the present invention provide a speaker with which a space required for attachment to an apparatus body is significantly reduced.

According to a preferred embodiment of the present invention, a speaker includes a speaker main body that is configured in which a permanent magnet, a voice coil, and a diaphragm are supported on a frame and an attachment part for attaching the speaker main body to an apparatus body, with the speaker being attached to the apparatus body as a result of a fitted hole provided in the attachment part being fitted over a projecting part provided on the apparatus body, wherein the attachment part is arranged such that at least a portion thereof overlaps with the speaker main body on the back side of the speaker main body.

Attachment foam preferably is interposed between a front-side portion of the speaker main body and the apparatus body as an ancillary element that is used to attach the speaker main body to the apparatus body.

An attachment rubber part preferably is interposed between the fitted hole provided in the attachment part and the projecting part provided on the apparatus body as an ancillary element that is used to attach the speaker main body to the apparatus body.

The attachment part preferably is formed from a metal plate and includes a rearward extension part that extends toward the back of the speaker main body and an inward extension part that extends toward the inside of the speaker main body on the back side of the speaker main body by being bent from the rearward extension part toward the inside of the speaker main body such that the bent line created by bending is parallel or substantially parallel to the direction of extension of the rearward extension part, at least a portion of the inward extension part overlaps with the speaker main body on the back side of the speaker main body, and the fitted hole is provided in the inward extension part.

The frame preferably is formed from a metal plate, the attachment part preferably is formed from the metal plate integrally with the frame and includes a rearward extension part that extends toward the back of the speaker main body by being bent from the frame toward the back of the speaker main body and an inward extension part that extends toward the inside of the speaker main body on the back side of the speaker main body by being bent from the rearward extension part toward the inside of the speaker main body such that the bent line created by bending is parallel or substantially parallel to the direction of extension of the rearward extension part, at least a portion of the inward extension part overlaps with the speaker main body on the back side of the speaker main body, and the fitted hole is provided in the inward extension part.

Assuming that a straight line passing though the center of the speaker main body from the back side toward the front side of this speaker main body is taken as the centerline, the speaker main body preferably has a shape having rotational symmetry about a 180-degree rotation with the centerline as the axis of rotation, the attachment part is provided in a pair, the fitted hole is provided in each of the pair of attachment parts, and the pair of attachment parts are configured such that the fitted holes respectively provided in the pair of attachment parts can be respectively fitted over a pair of projecting parts provided on the apparatus body in a specified first attitude of this speaker, and also such that the fitted holes respectively provided in the pair of attachment parts can be respectively fitted over the pair of projecting parts provided on the apparatus body in a second attitude of this speaker as well in which this speaker is rotated by 180 degrees from the first attitude with the centerline as the axis of rotation.

With a preferred embodiment of the present invention, the attachment part preferably is arranged such that at least a portion thereof overlaps with the speaker main body on the back side of the speaker main body, so the size of the speaker can be reduced, which makes it possible to significantly reduce the space required for the attachment to the apparatus body. Consequently, it is possible to increase the degree of freedom in the designing of electronic apparatuses on which the speaker is mounted and to improve the design characteristics of electronic apparatuses on which the speaker is mounted.

With another preferred embodiment of the present invention, the inward extension part of the attachment part provided with the fitted hole is bent such that the bent line created by bending is parallel or substantially parallel to the direction of extension of the rearward extension part (i.e., the direction from the back side toward the front side of the speaker main body). Therefore, even in cases where the bending precision of the inward extension part is poor, causing the angle of bending of the inward extension part to be shifted from the proper angle, or in cases where unnecessary force is applied when the fitted hole in the inward extension part is fitted over the projecting part of the apparatus body, causing the angle of bending of the inward extension part to be altered from the proper angle, the speaker main body is attached to the apparatus body in a proper attitude in which the direction from the back side toward the front side of the speaker main body is a proper direction. Consequently, in a configuration in which attachment foam is interposed between the front-side portion of the speaker main body and the apparatus body, the attachment foam is pressed against the apparatus body with a uniform force, which makes it possible to prevent deterioration of the quality and pressure of the sound that is output from the speaker and to ensure stable sound quality and sound pressure.

With a further preferred embodiment of the present invention, in cases where two speakers, such as left and right speakers, are mounted on an electronic apparatus, it is possible to use the same type of speakers.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a perspective view showing a schematic configuration of a speaker and an apparatus body according to a preferred embodiment of the present invention in a state in which the speaker is attached to the apparatus body, and FIG. 1B is a perspective view in a state in which the speaker of FIG. 1A is removed from the apparatus body.

FIG. 2A is a perspective view of the speaker of FIGS. 1A and 1B as seen from the back side, and FIG. 2B is an exploded perspective view of the speaker of FIGS. 1A and 1B as seen from the back side.

FIG. 3A is a perspective view of the speaker of FIGS. 1A and 1B as seen from the front side, and FIG. 3B is an exploded perspective view of the speaker of FIGS. 1A and 1B as seen from the front side.

FIG. 4A is a partial plan view of the speaker of FIGS. 1A and 1B as seen from the back side, FIG. 4B is a side view of the speaker of FIGS. 1A and 1B, and FIG. 4C is a side view of the speaker of FIGS. 1A and 1B as seen from another direction.

FIG. 5A is a perspective view showing a schematic configuration of a conventional speaker and an apparatus body in a state in which the speaker is attached to the apparatus body, and FIG. 5B is a perspective view in a state in which the speaker of FIG. 5A is removed from the apparatus body.

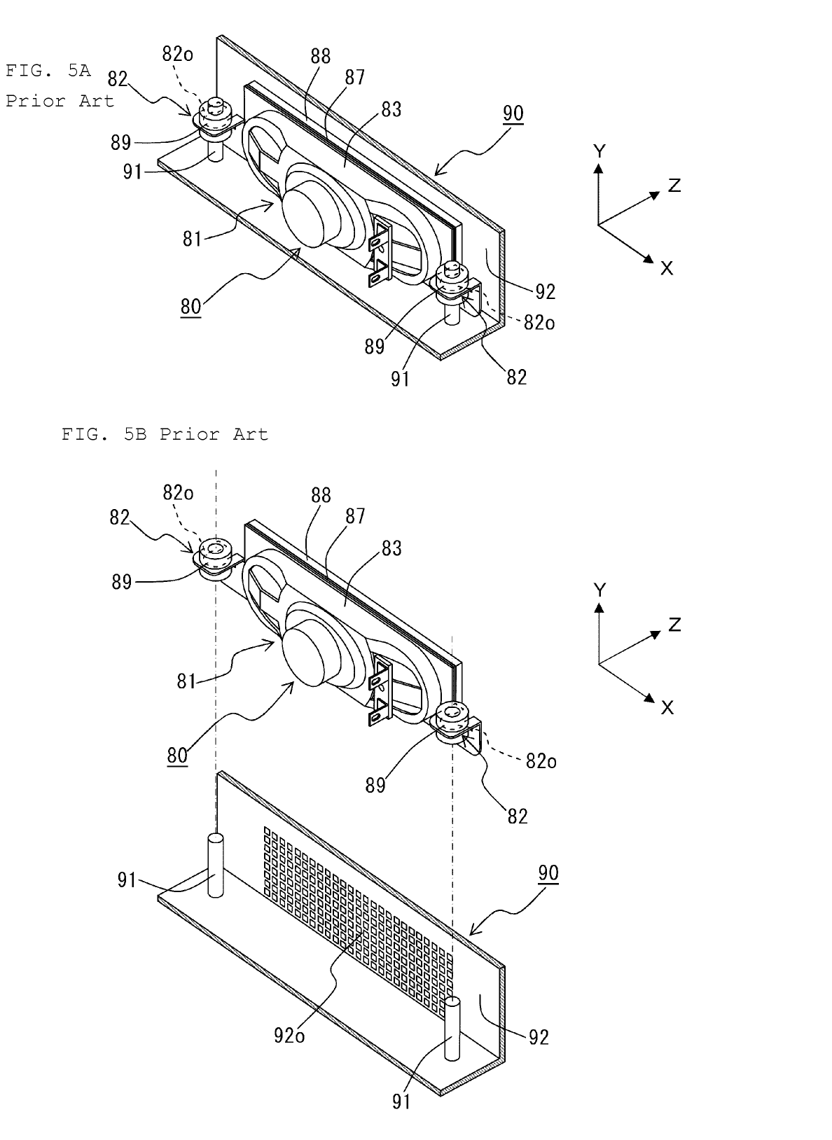

FIG. 6A is a perspective view of the speaker of FIGS. 5A and 5B as seen from the back side, and FIG. 6B is an exploded perspective view of the speaker of FIGS. 5A and 5B as seen from the front side.

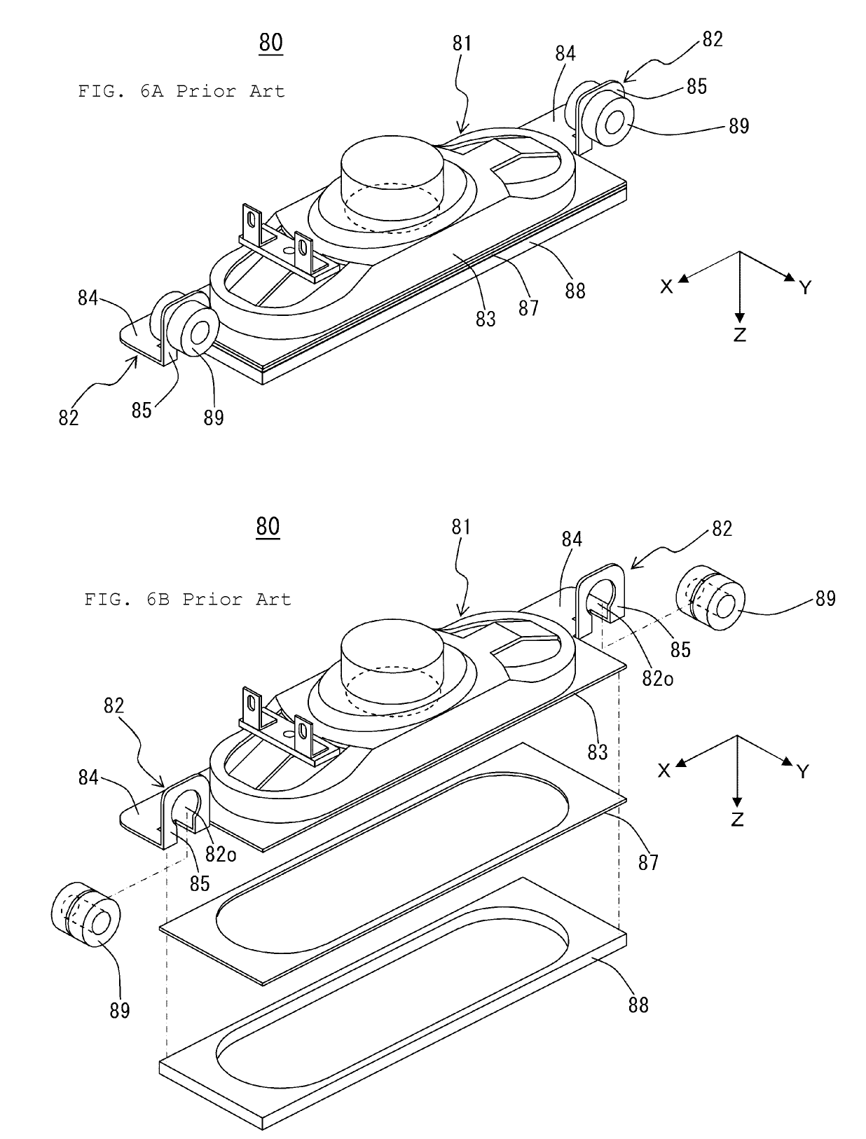

FIG. 7A is a perspective view of the speaker of FIGS. 5A and 5B as seen from the front side, and FIG. 7B is an exploded perspective view of the speaker of FIGS. 5A and 5B as seen from the front side.

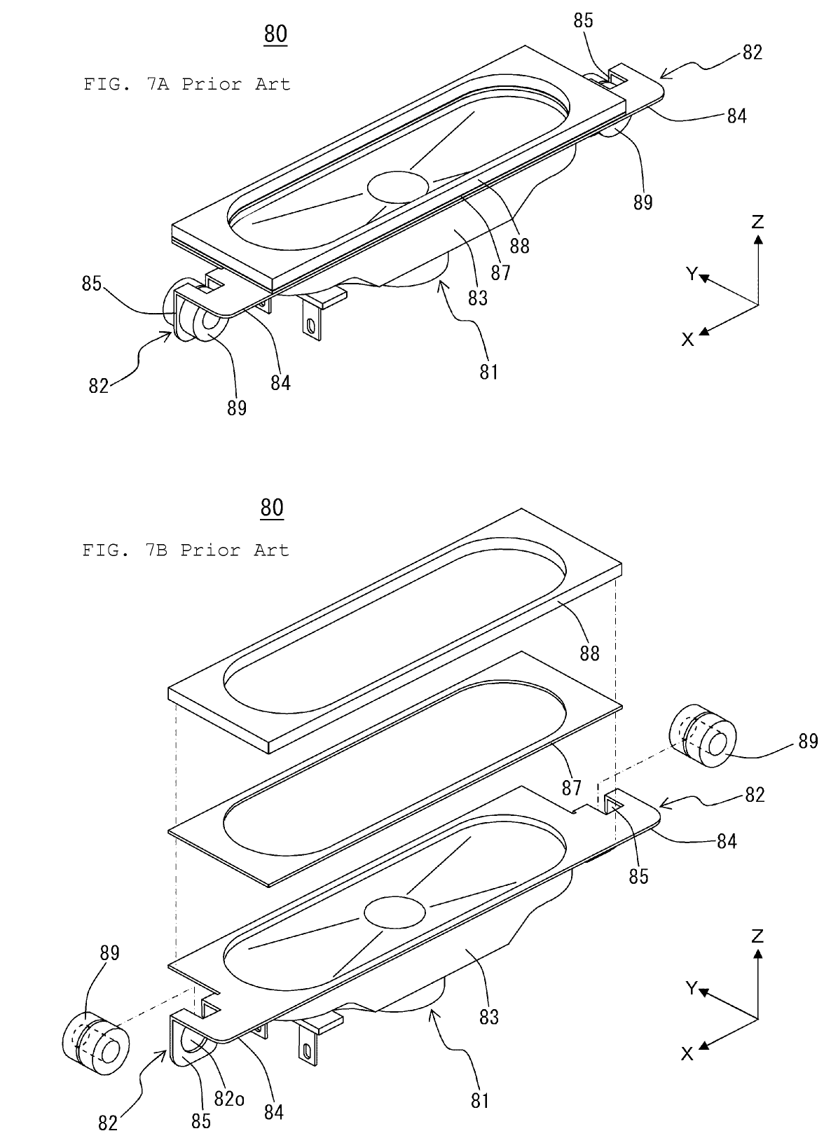

### DETAILED DESCRIPTION OF THE PREFERRED EMBODIMENTS

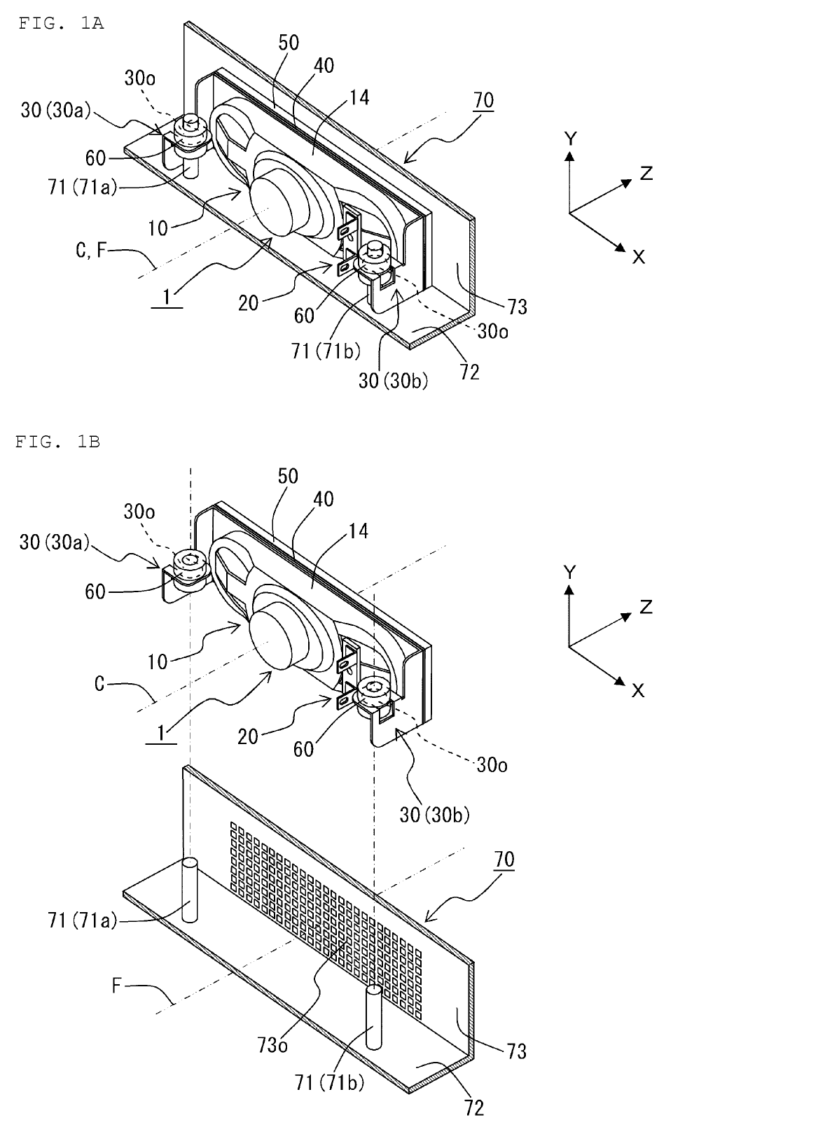

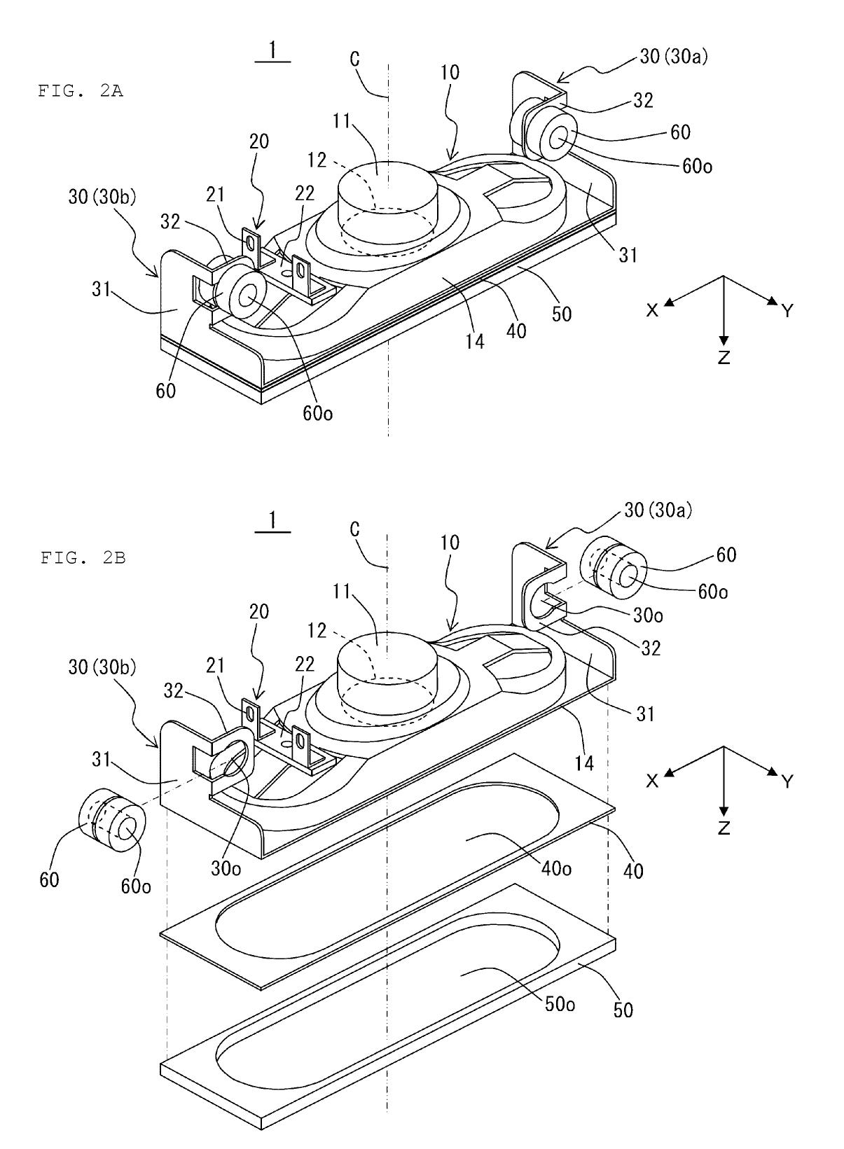

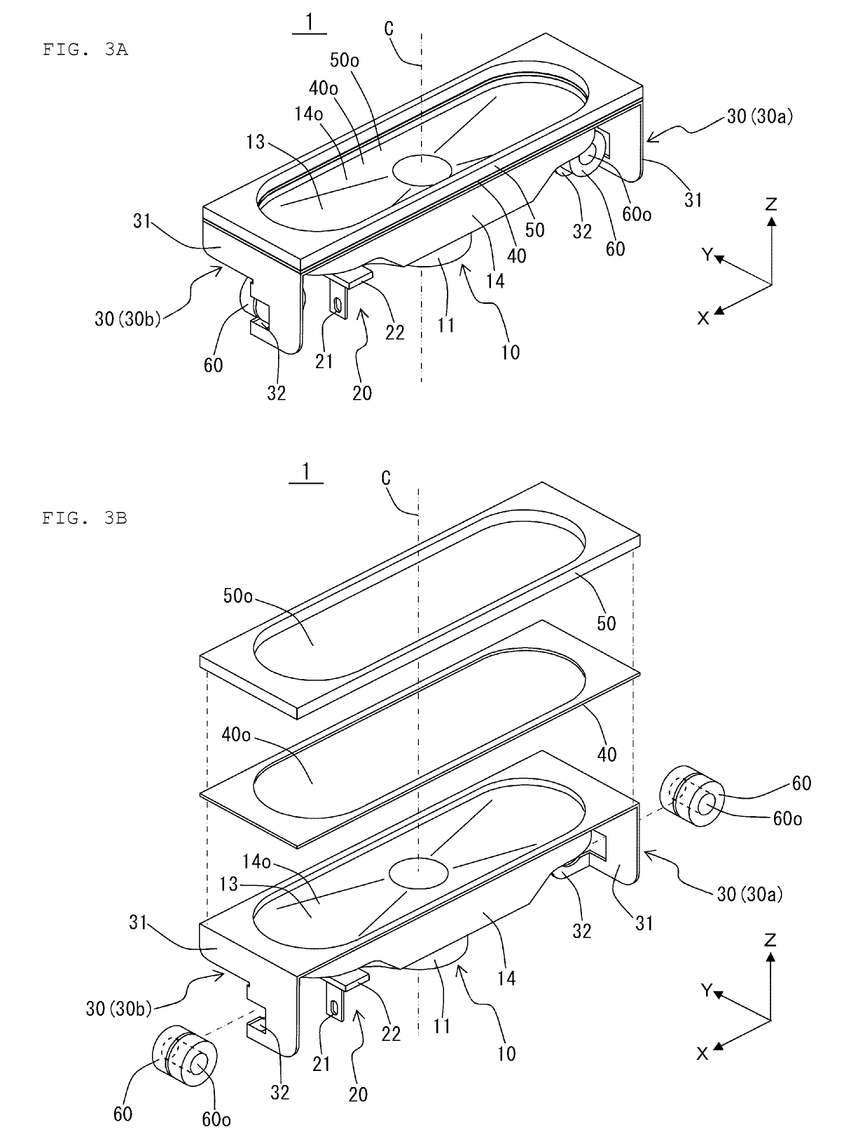

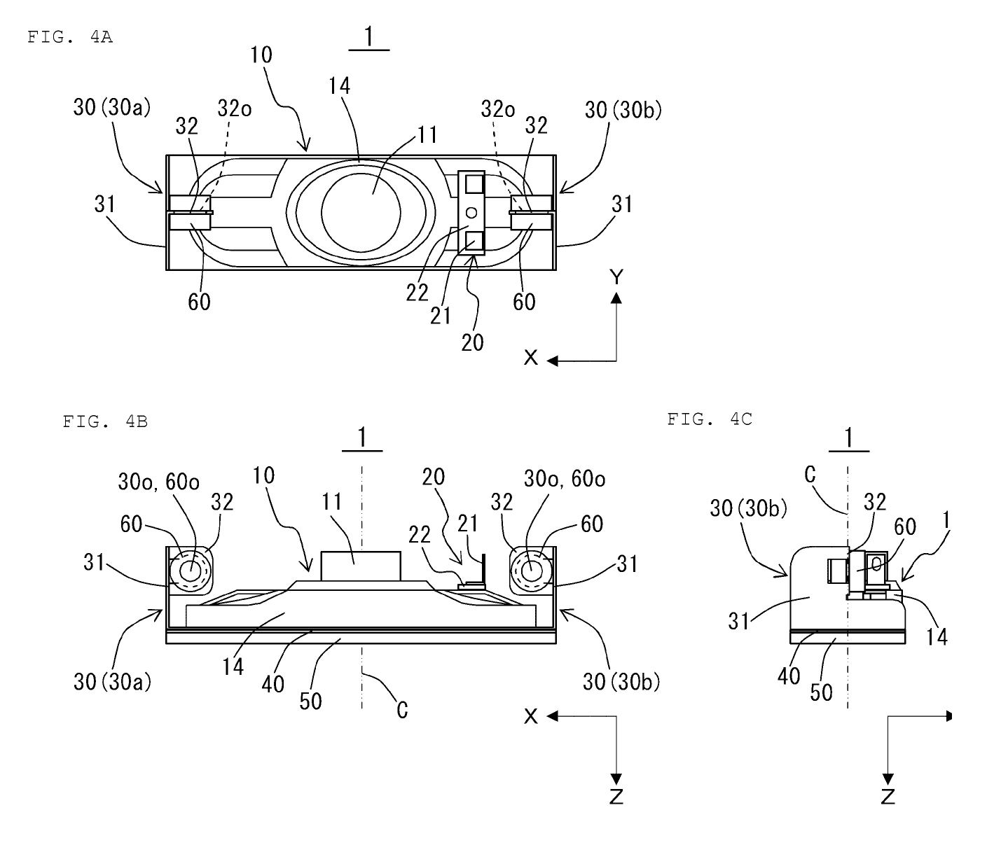

A speaker according to a preferred embodiment of the present invention will be described below with reference to figures. FIGS. 1A, 1B, 2A, 2B, 3A, 3B, 4A, 4B, and 4C show the configuration of the speaker according to the present preferred embodiment. The speaker 1 is a device that is mounted on an electronic apparatus such as a television receiver and that converts an electrical signal into sound and outputs the sound. The speaker 1 is attached to an apparatus body 70 and mounted on an electronic apparatus. The apparatus body 70 is a case for an electronic apparatus, for example.

The speaker 1 preferably includes a speaker main body 10 that converts an electrical signal into sound and outputs the sound, an electrical signal input part 20 to input an electrical signal that is to be converted into sound, and a pair of attachment parts 30 (30a and 30b) to attach the speaker main body 10 to the apparatus body 70.

The speaker main body 10 includes a permanent magnet 11, a voice coil 12, a diaphragm 13, and a frame 14 and has a configuration in which the permanent magnet 11, the voice coil 12, and the diaphragm 13 are supported on the frame 14.

The frame 14 preferably is formed from a metal plate. The frame 14 preferably is formed in a shape that surrounds the diaphragm 13, and the diaphragm 13 is disposed within a space surrounded by the frame 14. The frame 14 includes a sound releasing opening 14o to release the sound generated by the vibration of the diaphragm 13 to the outside of the speaker 1. The sound releasing opening 14o is provided on the front side of the diaphragm 13, so the front side of the diaphragm 13 faces the sound releasing opening 14o. The permanent magnet 11 and the voice coil 12 are provided on the back side of the diaphragm 13. The sound generated by the vibration of the diaphragm 13 is released to the outside of the speaker 1 from the sound releasing opening 14o.

In the speaker main body 10, the side on which the sound releasing opening 14o is provided (the side on which the diaphragm 13 faces the sound releasing opening 14o and the side on which the sound generated by the vibration of the diaphragm is released from the sound releasing opening 14o) is the front side of the speaker main body 10, and the side opposite from the front side of the speaker main body 10 (the side on which the permanent magnet 11 is provided) is the back side of the speaker main body 10. The surface on the front side of the speaker main body 10 (the surface on the front side of the frame 14) preferably has a planar shape and constitutes a planar surface that is perpendicular or substantially perpendicular to the direction from the back side toward the front side of the speaker main body 10. The direction indicated by arrow Z in the figures is the direction from the back side toward the front side of the speaker main body 10.

The speaker main body 10 preferably has a shape having the long-side direction and the short-side direction within a plane perpendicular or substantially perpendicular to the direction from the back side toward the front side of the speaker main body 10. That is, the speaker main body 10 preferably has a shape which is long in a given direction (long-side direction) and which is short in a direction perpendicular or substantially perpendicular to this direction (short-side direction) within a plane perpendicular or substantially perpendicular to the direction from the back side toward the front side of the speaker main body 10. The direction parallel or substantially parallel to the direction indicated by arrow X in the figures is the long-side direction of the speaker main body 10, while the direction parallel or substantially parallel to the direction indicated by arrow Y in the figures is the short-side direction of the speaker main body 10.

Furthermore, when the straight line passing through the center of the speaker main body 10 from the back side toward the front side of the speaker main body 10 is taken as the centerline C, the speaker main body 10 is configured in a shape having rotational symmetry about a 180-degree rotation with the centerline C as the axis of rotation.

The electrical signal input part 20 preferably has a configuration in which conductive input terminals 21 are provided on an insulating terminal stand 22 and is attached to the frame 14. The electrical signal input part 20 is disposed on the back side of the speaker main body 10 beside the permanent magnet 11 in the long-side direction of the speaker main body 10. Electrical signal lines for transmission (not illustrated) for transmission from the input terminals 21 to the voice coil 12 an electrical signal to be converted into sound are connected between the input terminals 21 and the voice coil 12. Electrical signal lines (not illustrated) for input into the speaker 1 an electrical signal to be converted into sound are connected to the input terminals 21.

The attachment part 30a is provided at the side end on one side of the speaker main body 10 in the long-side direction, and the attachment part 30b is provided at the side end on the other side of the speaker main body 10 in the long-side direction. Each of the attachment parts 30a and 30b is preferably arranged such that a portion thereof overlaps with the speaker main body 10 on the back side of the speaker main body 10. Fitted holes 30o for being fitted over projecting parts 71 provided on the apparatus body 70 are respectively provided in the attachment parts 30a and 30b.

Each of the attachment parts 30a and 30b preferably includes a rearward extension part 31 and an inward extension part 32. The rearward extension parts 31 respectively extend toward the back of the speaker main body 10 from the side ends of the frame 14 in the long-side direction of the speaker main body 10. The inward extension parts 32 respectively extend toward the inside of the speaker main body 10 from the rearward extension parts 31 on the back side of the speaker main body 10. Portions of the inward extension parts 32 overlap with the speaker main body 10 on the back side of the speaker main body 10. The fitted holes 30o are provided in the inward extension parts 32.

The rearward extension parts 31 and the inward extension parts 32 (i.e., the attachment parts 30a and 30b) are preferably made of a metal plate that is integral with the frame so as to define a unitary monolithic member. The rearward extension parts 31 are preferably formed by being bent at a bending angle of 90 degrees or approximately 90 degrees from the side ends of the frame 14 in the long-side direction of the speaker main body 10 toward the back of the speaker main body 10. The inward extension parts 32 are preferably formed by being bent at a bending angle of 90 degrees or approximately 90 degrees from the rearward extension parts 31 toward the inside of the speaker main body 10 such that the bend lines created by bending are parallel or substantially parallel to the direction of extension of the rearward extension parts 31 (i.e., the direction from the back side toward the front side of the speaker main body 10).

The fitted hole 30o in the attachment part 30a and the fitted hole 30o in the attachment part 30b are provided in positions in which the distance from the front surface of the speaker main body 10 (the front surface of the frame 14) is equal or substantially equal with respect to the direction parallel or substantially parallel to the direction from the back side toward the front side of the speaker main body 10. Moreover, the fitted hole 30o in the attachment part 30a and the fitted hole 30o in the attachment part 30b are provided in positions of symmetry with respect to the long-side direction of the speaker main body 10. Specifically, the fitted hole 30o in the attachment part 30a and the fitted hole 30o in the attachment part 30b are provided in positions in which the distance from the centerline C passing through the center of the speaker main body 10 from the back side toward the front side of the speaker main body 10 is equal or substantially equal with respect to the long-side direction of the speaker main body 10. In addition, the fitted hole 30o in the attachment part 30a and the fitted hole 30o in the attachment part 30b are both provided in the center position in the short-side direction of the speaker main body 10 with respect to the short-side direction of the speaker main body 10.

Accordingly, the fitted hole 30o in the attachment part 30a and the fitted hole 30o in the attachment part 30b are provided in positions of rotational symmetry about a 180-degree rotation with the centerline C passing through the center of the speaker main body 10 from the back side toward the front side of the speaker main body 10 as the rotational axis.

The apparatus body 70 will now be described. The apparatus body 70 preferably includes a pair of projecting parts (71a and 71b), a bottom wall 72, and a front wall 73. As was described above, the apparatus body 70 is a case for an electronic apparatus, for example. The pair of projecting parts (71a and 71b), the bottom wall 72, and the front wall 73 are preferably formed as an integral unit from a resin so as to define a unitary monolithic member.

The front wall 73 rises vertically from the bottom wall 72. The front wall 73 preferably includes a sound passing part 73o including numerous fine holes for passing sound emitted from the speaker 1. The sound passing part 73o preferably is formed such that the distance from the center of the sound passing part 73o to the bottom wall 72 is equal or substantially equal to the distance from the center of the speaker main body 10 to either end edge of the speaker main body 10 (frame 14) in the short-side direction.

Each of the projecting parts 71a and 71b protrudes vertically from the bottom wall 72. Specifically, the projecting parts 71a and 71b extend parallel or substantially parallel to each other and extend parallel or substantially parallel to the front wall 73 as well. The space between the projecting part 71a and the projecting part 71b is equal or substantially equal to the space between the fitted hole 30o in the attachment part 30a and the fitted hole 30o in the attachment part 30b of the speaker 1, and the length of each of the projecting parts 71a and 71b (the distance from the bottom wall 72 to the tip end) is longer than the distance from either end edge of the speaker main body 10 in the short-side direction to the fitted holes 30o in the attachment parts 30a and 30b.

Furthermore, the projecting parts 71a and 71b are preferably arranged so as to be lined up in parallel or substantially in parallel to the front wall 73 and provided in positions in which the distance from the front wall 73 is equal or substantially equal with respect to the direction perpendicular or substantially perpendicular to the front wall 73. Moreover, the projecting parts 71a and 71b preferably are provided in positions of symmetry with the position of the sound passing part 73o as the reference with respect to the direction of alignment of the projecting parts 71a and 71b (the direction parallel or substantially parallel to both the bottom wall 72 and the front wall 73). That is, the projecting part 71a and the projecting part 71b preferably are provided in positions in which the distance from the straight line F passing through the center of the sound passing part 73o perpendicularly or substantially perpendicularly to the front wall 73 with respect to the direction of alignment of the projecting parts 71a and 71b is equal or substantially equal.

The speaker 1 is attached to the apparatus body 70 as a result of the fitted holes 30o in the attachment parts 30a and 30b being respectively fitted over the projecting parts 71 of the apparatus body 70 in an attitude in which the front side of the speaker main body 10 is caused to face the front wall 73 (sound passing part 73o) of the apparatus body 70.

Because of the configuration of the fitted holes 30o in the attachment parts 30a and 30b and the configuration of the aforementioned projecting parts 71a and 71b, the fitted holes 30o in the attachment parts 30a and 30b can be fitted over the projecting parts 71a and 71b of the apparatus body 70 using two fitting methods (first and second methods) in which the attitudes of the speaker 1 are different.

The first fitting method is a fitting method in which the fitted hole 30o in the attachment part 30a is fitted over the projecting part 71a of the apparatus body 70, while the fitted hole 30o in the attachment part 30b is fitted over the projecting part 71b of the apparatus body 70. The attitude of the speaker 1 in this fitting method is referred to as the first attitude. The second fitting method is a fitting method in which the fitted hole 30o in the attachment part 30b is fitted over the projecting part 71a of the apparatus body 70, while the fitted hole 30o in the attachment part 30a is fitted over the projecting part 71b of the apparatus body 70. The attitude of the speaker 1 in this fitting method is referred to as the second attitude. The second attitude is an attitude in which the speaker 1 is rotated by 180 degrees from the first attitude with the centerline C as the axis of rotation.

That is, the pair of attachment parts 30a and 30b preferably are configured such that the fitted holes 30o respectively provided in the pair of attachment parts 30a and 30b can be fitted over the pair of projecting parts 71a and 71b provided on the apparatus body 70 in the first attitude of the speaker 1, and also such that the fitted holes 30o respectively provided in the pair of attachment parts 30a and 30b can be fitted over the pair of projecting parts 71a and 71b provided on the apparatus body 70 in the second attitude of the speaker 1 in which the speaker 1 is rotated by 180 degrees from the first attitude with the centerline C as the axis of rotation.

In addition, the speaker 1 preferably includes heavy attachment paper 40, attachment foam 50, and attachment rubber parts 60 as ancillary elements that are used to attach the speaker main body 10 to the apparatus body 70.

The heavy attachment paper 40 and the attachment foam are members that are interposed between the front-side portion of the speaker main body 10 (the front-side portion of the frame 14) and the front wall 73 of the apparatus body 70 such that no gap is created between the front-side portion of the speaker main body 10 (the front-side portion of the frame 14) and the front wall 73 of the apparatus body 70 when the speaker 1 is attached to the apparatus body 70.

The heavy attachment paper 40 preferably has a uniform or substantially uniform thickness, and an opening 40o is formed in the center. The heavy attachment paper 40 is bonded to the front-side portion of the speaker main body 10 (the front-side portion of the frame 14) such that the opening 40o coincides with the sound releasing opening 14o in the frame 14.

The attachment foam 50 preferably has a uniform thickness, and an opening 50o is formed in the center. The attachment foam 50 is bonded to the heavy attachment paper 40 such that the opening 50o coincides with the opening 40o in the heavy attachment paper 40. That is, the attachment foam 50 is bonded to the front-side portion of the speaker main body 10 (the front-side portion of the frame 14) via the heavy attachment paper 40 such that the opening 50o coincides with the sound releasing opening 14o in the frame 14.

The thicknesses of the heavy attachment paper 40 and attachment foam 50 are set at dimensions at which the attachment foam 50 is pressed against the front wall 73 of the apparatus body 70 via the heavy attachment paper 40 by the speaker main body 10 when the speaker 1 is attached to the apparatus body 70.

The attachment rubber parts 60 are members that are respectively interposed between the fitted holes 30o in the attachment parts 30 and the projecting parts 71 of the apparatus body 70 such that no gap is produced between the fitted holes 30o in the attachment parts 30 and the projecting parts 71 of the apparatus body 70 when the speaker 1 is attached to the apparatus body 70. Each of the attachment rubber parts 60 preferably is circular cylindrical or substantially circular cylindrical in shape, and a through-hole 60o is formed therein. The attachment rubber parts 60 are designed to be attached to and removed from the fitted holes 30o in the attachment parts 30 by being deformed.

Next, a non-limiting example of a method for attaching the speaker 1 to the apparatus body 70 will be described. The speaker 1 is attached to the apparatus body 70 as follows.

First, the attachment rubber parts 60 are respectively fitted into the fitted holes 30o in the attachment parts 30, thus attaching the attachment rubber parts 60 to the attachment parts 30. Subsequently, the fitted holes 30o in the attachment parts 30 are respectively fitted over the projecting parts 71 of the apparatus body 70 in a state in which the attachment rubber parts 60 are attached to the attachment parts 30. Specifically, the through-holes 60o in the attachment rubber parts 60 attached to the attachment parts 30 are fitted over the projecting parts 71 of the apparatus body 70. At this point, with the front side of the speaker main body 10 being caused to face the front wall (sound passing part 73o) of the apparatus body 70, the through-holes 60o in the attachment rubber parts 60 attached to the attachment parts 30 are fitted over the projecting parts 71 of the apparatus body 70 in the first attitude or second attitude while the attachment foam 50 is pressed against the front wall 73 of the apparatus body 70.

Then, in a state in which the through-holes 60o in the attachment rubber parts 60 attached to the attachment parts 30 are fitted over the projecting parts 71 of the apparatus body 70, the speaker 1 is pushed toward the bottom wall 72, thus causing an end edge of the speaker main body 10 (frame 14) in the short-side direction to contact the bottom wall 72 of the apparatus body 70. Consequently, the speaker 1 is attached to the apparatus body 70. The speaker 1 is attached to the apparatus body 70 in this manner.

In a state in which the speaker 1 is attached to the apparatus body 70, the attachment foam 50 is interposed in a compressed state between the front-side portion of the speaker main body 10 (the front-side portion of the frame 14) and the front wall 73 of the apparatus body 70, and the attachment rubber parts 60 are respectively interposed between the fitted holes 30o provided in the attachment parts 30 and the projecting parts 71 provided on the apparatus body 70.

Note that in FIGS. 1A and 1B, a case is illustrated in which the speaker 1 is attached to the apparatus body 70 in the first attitude (with the fitted hole 30o in the attachment part 30a being fitted over the projecting part 71a and the fitted hole 30o in the attachment part 30b being fitted over the projecting part 71b). If the speaker 1 is attached to the apparatus body 70 in the second attitude (with the fitted hole 30o in the attachment part 30b being fitted over the projecting part 71a and the fitted hole 30o in the attachment part 30a being fitted over the projecting part 71b), then the position (and direction) of the electrical signal input part 20 will be reversed compared to the case of the attachment in the first attitude.

With the speaker 1 having such a configuration, the attachment parts 30 are preferably arranged so as to partially overlap with the speaker main body 10 on the back side of the speaker main body 10, so the size of the speaker 1 can be reduced, which makes it possible to reduce the space required for the attachment to the apparatus body 70. Consequently, the degree of freedom in the designing of electronic apparatuses on which the speaker 1 is mounted is increased, which can improve the design characteristics of electronic apparatuses on which the speaker 1 is mounted.

Furthermore, the inward extension parts 32 of the attachment parts 30 respectively provided with the fitted holes 30o are bent such that the bent lines created by bending are parallel to the direction of extension of the rearward extension parts 31 (i.e., the direction from the back side toward the front side of the speaker main body 10). For this reason, the speaker main body 10 is attached to the apparatus body 70 in a proper attitude in which the direction from the back side toward the front side of the speaker main body 10 is a proper direction (direction perpendicular or substantially perpendicular to the front wall 73) even in cases where the bending precision of the inward extension parts 32 is poor, causing the angle of bending of the inward extension parts 32 to be shifted from the proper angle (90 degrees), or in cases where unnecessary force is applied when the fitted holes 30o in the inward extension parts 32 are fitted over the projecting parts 71 of the apparatus body 70, causing the angle of bending of the inward extension parts to be altered from the proper angle. Consequently, the attachment foam 50 can be pressed against the front wall 73 of the apparatus body 70 with a uniform force, which makes it possible to prevent deterioration of the quality and pressure of the sound that is output from the speaker 1 and to ensure stable sound quality and sound pressure.

Moreover, the speaker main body 10 preferably has a shape having rotational symmetry about a 180-degree rotation with the centerline C passing through the center of the speaker main body 10 from the back side toward the front side of the speaker main body 10 being taken as the axis of rotation. Then, the pair of attachment parts 30a and 30b are configured such that the fitted holes 30o respectively provided in the pair of attachment parts 30a and 30b can be fitted over the pair of projecting parts 71a and 71b provided on the apparatus body 70 in the specified first attitude of the speaker 1 and also such that the fitted holes 30o respectively provided in the pair of attachment parts 30a and 30b can be fitted over the pair of projecting parts 71a and 71b provided on the apparatus body 70 in the second attitude in which the speaker 1 is rotated by 180 degrees from the first attitude with the centerline C as the axis of rotation. Consequently, in cases where two speakers 1 are mounted on the left and right of an electronic apparatus, the speakers 1 can be shared between the left and right. That is, when two speakers 1 are mounted on the left and right of an electronic apparatus, it is possible to use the same type of speaker for the speakers 1.

Note that the present invention is not limited to the configuration of the aforementioned preferred embodiment, and various modifications are possible. For example, with regard to the attachment parts, attachment parts formed from a resin may be attached to the frame of the speaker main body. In addition, the frame of the speaker main body may be formed from a resin. In this case, the attachment parts may be formed from a resin integrally with the frame, or attachment parts formed from metal plates may be attached to the frame.

Furthermore, the attachment foam may be bonded to the front wall of the apparatus body as part of the apparatus body. In this case, the heavy attachment paper may be bonded to the front-side portion of the speaker main body (the front-side portion of the frame) or may also be bonded as part of the apparatus body to the attachment foam that is bonded to the front wall of the apparatus body. Moreover, it would also be possible not to provide any heavy attachment paper. In this case, the attachment foam may be bonded directly to the front-side portion of the speaker main body (the front-side portion of the frame) or may also be bonded to the front wall of the apparatus body as part of the apparatus body. In addition, the attachment rubber parts may be provided on the projecting parts of the apparatus body as part of the apparatus body. In this case, the attachment rubber parts may be formed integrally with the projecting parts as part of the projecting parts. Furthermore, the apparatus body may also be configured as a separate body from a case for an electronic apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A speaker comprising:
a speaker main body including:
a frame;
a permanent magnet;
a voice coil;
a diaphragm; and
an attachment part including a fitting hole and arranged to attach the speaker main body to an apparatus body; wherein
the permanent magnet, the voice coil and the diaphragm are supported on the frame; wherein
the speaker main body is configured to be attached to the apparatus body as a result of the fitted hole provided in the attachment part being fitted over a projecting part provided on the apparatus body; and
the attachment part is arranged such that at least a portion thereof overlaps with the speaker main body on a back side of the speaker main body.

2. The speaker according to claim 1, further comprising attachment foam interposed between a front-side portion of the speaker main body and the apparatus body to assist in attaching the speaker main body to the apparatus body.

3. The speaker according to claim 1, further comprising an attachment rubber part interposed between the fitted hole provided in the attachment part and the projecting part provided on the apparatus body as an ancillary part to assist in attaching the speaker main body to the apparatus body.

4. The speaker according to claim 1, wherein the attachment part is defined by a metal plate and includes a rearward extension part that extends toward a back side of the speaker main body and an inward extension part that extends toward an inside of the speaker main body on the back side of the speaker main body by being bent from the rearward extension part toward the inside of the speaker main body such that a bend line created by bending is parallel or substantially parallel to a direction of extension of the rearward extension part; wherein
at least a portion of the inward extension part overlaps with the speaker main body on the back side of the speaker main body; and
the fitted hole is provided in the inward extension part.

5. The speaker according to claim 1, wherein
the frame is defined by a metal plate;
the attachment part is defined by the metal plate and is integral with the frame such that the frame and attachment part are defined by a single unitary monolithic member;
the attachment part includes:
a rearward extension part that extends toward a back of the speaker main body by being bent from the frame toward the back of the speaker main body; and
an inward extension part that extends toward an inside of the speaker main body on the back side of the speaker main body by being bent from the rearward extension part toward the inside of the speaker main body such that a bend line created by bending is parallel or substantially parallel to a direction of extension of the rearward extension part; wherein
at least a portion of the inward extension part overlaps with the speaker main body on a back side of the speaker main body; and
the fitted hole is provided in the inward extension part.

6. The speaker according to claim 1, wherein assuming a straight line passing though a center of the speaker main body from a back side toward a front side of the speaker main body is taken as a centerline, the speaker main body has a shape having rotational symmetry about a 180-degree rotation with the centerline as an axis of rotation;
the attachment part is provided in a pair;
the fitted hole is provided in each of the pair of attachment parts; and
the pair of attachment parts are configured such that the fitted holes respectively provided in the pair of attachment parts are arranged to be respectively fitted over a pair of projecting parts provided on the apparatus body in a specified first attitude of the speaker, and also such that the fitted holes respectively provided in the pair of attachment parts are arranged to be respectively fitted over the pair of projecting parts provided on the apparatus body in a second attitude of the speaker as well in which the speaker is rotated by 180 degrees from the first attitude with the centerline as the axis of rotation.
